(19) United States
(12) Patent Application Publication
(10) Pub. No.: US 2004/0075641 A1
(43) Pub. Date: Apr. 22, 2004

(54) Input device and methods of use within a computing system

(76) Inventor: Simon Widdowson, Dublin, CA (US)

Correspondence Address: HEWLETT-PACKARD COMPANY, Intellectual Property Administration, P.O. Box 272400, Fort Collins, CO, 80527-2400, US

(21) Appl. No.: 10/277,857

(22) Filed: Oct. 22, 2002

(51) Int. Cl. G09G 5/00

(52) U.S. Cl. 345/156

(57) ABSTRACT

A system, method, and apparatus for providing user input through an input device to a computing system (40) including a primary display screen (43) is described in which a secondary display unit (44) receives user input in the form of tactile contact to allow intuitive interaction with the full image displayed on the primary display screen. The secondary display unit can be sized to facilitate its integration within a portable computing device such as a laptop.

### FIELD OF THE INVENTION

The present invention relates to a system and method for receiving user input to a computing system, and in particular this disclosure provides a system and method thereof of using a touch sensitive secondary display unit as an input device to a computing system.

### BACKGROUND OF THE INVENTION

In general, it is well know that a computer system includes a display screen for displaying and viewing an image generated and provided in combination by the computer system's processing unit (e.g., CPU, microprocessor, etc.) and data storage unit (RAM, ROM, flash memory, etc.). The computer system further includes an input device that allows the user to interact with the computer system. One well-known input device is a keyboard. Although a keyboard allows a user to input data into the computer system, it does not allow a user to intuitively interact with the image displayed on the display screen. In other words, it is often desirable to have an input device in which the user's physical movements with the input device results in corresponding movements of objects or actions viewed on the display screen.

One such input device is the computer mouse. For instance, when a user moves the mouse on a mouse pad, a corresponding movement (e.g., left, right, etc.) of a displayed curser occurs on the display screen. Similarly, software applications in the form of graphical user interfaces allow a user to use a mouse as a “pointer”, a “pen”, a “paint brush” or an “eraser” to interact directly with a displayed image. For instance, a user can select menu options (e.g., color and function) from a tool bar on the graphical interface to cause the curser to simulate the function of a paint brush having a selected color. Moving the mouse on a mouse pad, can cause a similar movement of the displayed image of the “paint brush” thereby simulating the act of painting on the displayed image.

A laptop computer is a computer system that is integrated within a single foldable chassis for portability. In general, instead of utilizing a mouse as an intuitive input device, a laptop computer commonly includes a touch pad, which is more adapted to the laptop's portability. For instance, a laptop computer 10 (FIG. 1) having a single chassis including an upper portion 11 housing a display screen 12 and a lower portion 13 incorporating a keyboard 14 further includes an input device in the form of a touchpad (15) integrated within the lower portion (13). Similar to the mouse, the touchpad provides the user an intuitive manner in which to interact with the image displayed on the display screen 12. For instance, the user can move a curser across the displayed image on screen 12 by moving their finger or a stylus across the surface of touchpad 15 in the same manner. Since motion on the pad generally correspond to scaled motion on the display screen, the user's interaction with the touch pad simulates interaction with the displayed image.

However, the problem with the touchpad input device, as well as the mouse input device, is that the user interacts with the displayed image indirectly by interacting with a touchpad or mouse pad and since the location correspondence between the touchpad or mouse pad and the display screen is inexact, the intuitiveness of these devices is diminished.

Touch screen technology improves on the mouse and touchpad input devices because unlike the mouse and the touchpad, it allows a user to directly interact with the displayed image by touching the display screen. A touch screen includes a pressure sensitive layer overlaid on a display screen that produces electrical signals which correspond to pressure on the touch screen applied by a finger, a stylus, or the like. Touch screens include, but are not limited to, resistive film type and capacitive touch screens. The pressure sensitive layer can be overlaid upon either a CRT monitor or a LCD (or similar flat panel) display screen. Due to differences in the design and construction of the CRT monitor vs. LCD flat panel display screens, CRT display screens tend to provide a minimized correspondence between the user's input (e.g., location where the screen is touched) and the resulting interaction viewed on the displayed image. Moreover, a CRT monitor tends to be less expensive and consume more space when compared to a comparably sized LCD flat panel display screens. As a result applications requiring less precision and reduced cost, and not having space concerns utilize touch screen CRT monitors. For instance, CRT touch screens are often used as user input devices for electronic transaction terminal devices such as automated teller machines (ATMs) and point of sale (POS) terminals since they require less precise interaction with the displayed image and because high quality images are not required.

Alternatively, in order to facilitate portability, small LCD touch screens are commonly employed within hand held devices 20 (FIG. 2), such as PDAs, where a single LCD touch screen 21 is used to display a menu of selections. In this case, the LCD screen is often too small for the user to touch directly with their finger and, as a result, a stylus is used to touch the displayed icons to make a selection. LCD touch screens are also known to be used in laptop computers where the LCD touch screen is used as the primary display (12, FIG. 1) in the laptop.

Another known application of LCD touch screen technology in the graphic arts field is realized in a peripheral device referred to as a touch screen “tablet”. As shown in FIG. 3, a touch screen “tablet” 30 having a full sized LCD touch screen 31 is coupled as a peripheral device to a computing system 32. The “tablet” can lay flat to allow the user to interact with it as one would with a sheet of drawing paper by “drawing” directly on the “tablet” with a stylus or their finger. A large LCD touch screen is provided since the graphic arts application of the touch screen often requires precise correspondence between the users interaction with the input device and the resulting action in the displayed image. Although this system provides an extremely intuitive tool for the graphic artist, the LCD touch screen can be very costly due to the size of both the LCD screen and the size and construction of the overlaid pressure sensitive layer upon it. Consequently, this option can become cost prohibitive to non-professional graphic artist or typical user. Moreover, although this solution provides a highly precise, interactive, and intuitive input device, it is not very portable.

Hence a need exists for a system, method, and apparatus for providing an intuitive, convenient, cost effective manner in which to interact with a display screen using touch sensitive display screen technology.

### SUMMARY OF THE INVENTION

A system, apparatus, and method for providing user input to a computing system are described. According to one embodiment, a computing system that includes a processing portion, a memory portion, and a primary display screen for displaying a full image in response to image data provided from at least one of the processing or memory portions, also includes a secondary display unit for displaying at least a portion of the full image. The secondary display unit also receives user input through tactile contact with the secondary display unit. The secondary display unit is smaller than the primary display screen and is physically integrated within a single chassis along with the processing portion, the memory portion, and the primary display screen thereby providing an integrated user input solution.

According to another embodiment, a method is described for providing a user input to a computing system that is performed by displaying a full image on a first display screen thereby providing user viewing capabilities of the full image and displaying at least a portion of the full image on a second display unit. User input is then received through the second display unit through tactile contact with the second display unit to allow user interaction with the full image displayed on the first screen.

According to still another embodiment, an apparatus for receiving user input in a computing system is described, where the computing system includes at least a first display screen for displaying a full image. The apparatus further includes a second display screen that is smaller than the first display screen for displaying at least a portion of the full image. The apparatus also includes a means for receiving user tactile contact and mapping the location of the user tactile contact to a coordinate location on the at least a portion of the full image so as to allow user interaction with the full image displayed on the first display screen. The receiving means is transparent and overlaid upon the second display screen. In addition, the apparatus is formed such that the second display screen is integrated within a single chassis with the first display screen.

### BRIEF DESCRIPTION OF THE DRAWINGS

FIG. 1 illustrates a laptop computer having a touchpad;

FIG. 2 illustrates a PDA having a touch screen as an input;

FIG. 3 illustrates a touch screen tablet coupled to a computing system;

FIG. 4 is an embodiment of a system including a secondary touch sensitive display unit for receiving user input;

FIG. 5 is an embodiment of an apparatus for receiving user input via tactile contact;

FIG. 6 is an embodiment of a method of providing user input to a computing system through a secondary touch sensitive display unit.

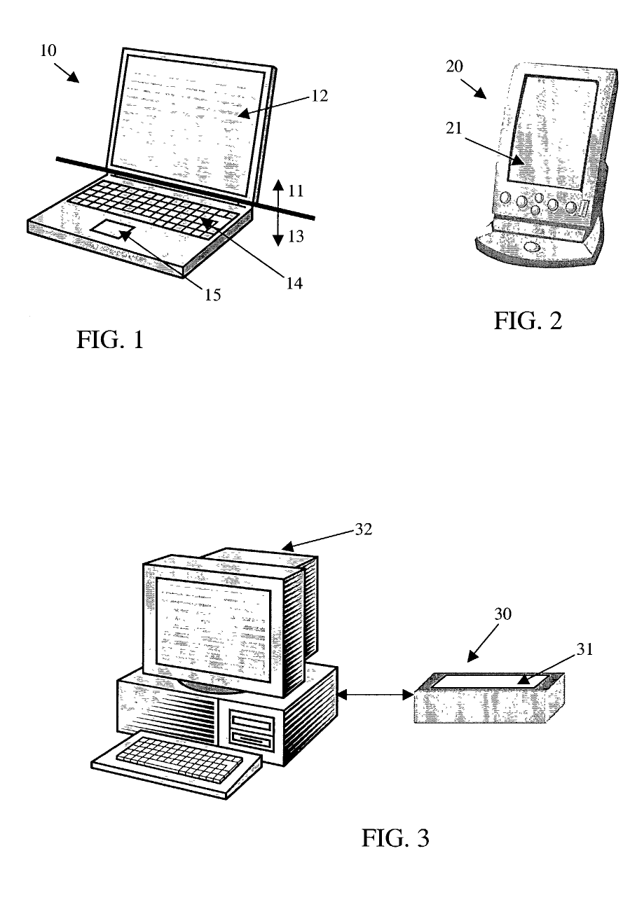

### DETAILED DESCRIPTION OF THE INVENTION

In general, the present invention is a technique for providing user input through an input device to a computing system. Specifically, a system and an apparatus are described that use a secondary display unit for receiving user input in the form of tactile contact. A method is described in which a user input is received through tactile contact with a secondary display. The system, apparatus, and method are particularly adapted to a laptop computer wherein the laptop's primary display is used for viewing a full image and a secondary touch sensitive smaller display unit is provided and used to receive user input via tactile contact. It should be understood that in accordance with this disclosure a touch sensitive screen (or touch screen) corresponds to any display unit that can display an image, has a display surface that is sensitive to tactile contact, and can map the location of the tactile contact with respect to the coordinate system of the image displayed by the display unit.

FIG. 4 shows a first embodiment of a computing system 40. The computing system 40 is physically integrated into a single chassis including a first portion 41 and a second portion 42. That is, all of the elements of the computing system are housed within a single framework, the chassis. In one embodiment, the computing system is portable (e.g., a laptop). The computing system 40 at least includes a processing portion (not shown) and a memory portion (not shown). As is well known, a computing system can include many other elements, however these other elements are beyond the scope of this disclosure. The processing portion and the memory portion at least function to generate or provide image data corresponding to a full image for displaying. The full image (e.g., circle 43A) is displayed by a primary display screen 43. The primary display screen 43 is housed within the first portion 41 of the computer system chassis. The system 40 further includes a secondary display unit 44 that is housed within the second portion 42 of the chassis of computing system 40. The secondary display unit 44 at least displays a portion of the full image that is displayed by the primary display screen 43. In the embodiment shown in FIG. 4, the secondary display unit 44 displays the full image. In particular, display unit 44 displays a circle 44A corresponding to circle 43A displayed by screen 43. In addition, the secondary display unit 44 functions to receive user input by tactile contact with the secondary display unit. In particular, the user can provide user input to the computing system by touching the secondary display unit with either a finger or a stylus, or the like. For instance, the user can cause a curser to move across the primary display screen by moving a stylus across the image displayed on the secondary display screen. As a result, the user can directly interact with the full image displayed by the primary display screen. As seen in FIG. 4, the secondary display unit is smaller than the primary display screen such that the secondary display unit displays a smaller image than the primary display screen. It should be noted that one advantage of placing the secondary display unit in the second portion 42 is that the user can interact with it in a natural manner such as with a drawing tablet since it is in a flat position with respect to the user. In contrast, laptop computers having a touch screen for the primary display screen 43 in the first portion 41 are difficult to interact with since they are at an awkward angle for the user to draw upon.

The secondary display unit 44 can display only a portion of the full image displayed by the primary display screen 43. For instance, the secondary display unit can display a small physical block (e.g., center block) of the image. In one embodiment, the user can select a block of the full image using the secondary display unit as an input device or using a different input device (e.g., a touchpad or a mouse 45) thereby causing the selected block to be displayed on the secondary display unit. This allows the user to interact with this particular block of the image. Moreover, the secondary display unit can include a scaling option such that the image portion or the full image that is displayed by the secondary display unit is scaled. For instance, the user may want to magnify or demagnify the image displayed by the secondary display unit to facilitate interacting with it.

In still another embodiment in which a graphical interface is displayed on the primary display screen, the user can move all or portions of menu elements to the secondary display unit. This type of display scenario is useful for graphic artists that use graphical interfaces having a menu with a large selection of options and icons that can cover up the full image displayed on the primary display screen that is being created or edited. By moving a portion or all of the graphical interface icons or menu elements from the primary display screen to the second display unit, the full image displayed on the primary display screen is free from distractions. Hence in accordance with one embodiment, the secondary display unit displays user interface control objects (e.g., menu options and icons).

In one embodiment, the user may use other input devices in conjunction with the secondary display unit. For instance, a peripheral (i.e., not integrated within the chassis of the computer system 40) mouse 45 can be connected to the computing system. Alternatively or in addition, a touchpad (not shown in FIG. 4) can be included adjacent to the secondary display unit 44. The other input devices can be used in conjunction with the secondary display unit 44 to allow, for example, a graphical interface user to select menu tools with the other input devices with one hand and apply the tools to the image displayed on the secondary display unit 44 with the other hand. User input can take the form of moving a finger, stylus, or the like on the secondary display unit to select displayed control elements (e.g., icons, menus) or take the form of a user's freehand drawing using a graphic tool on the image displayed on the second display unit.

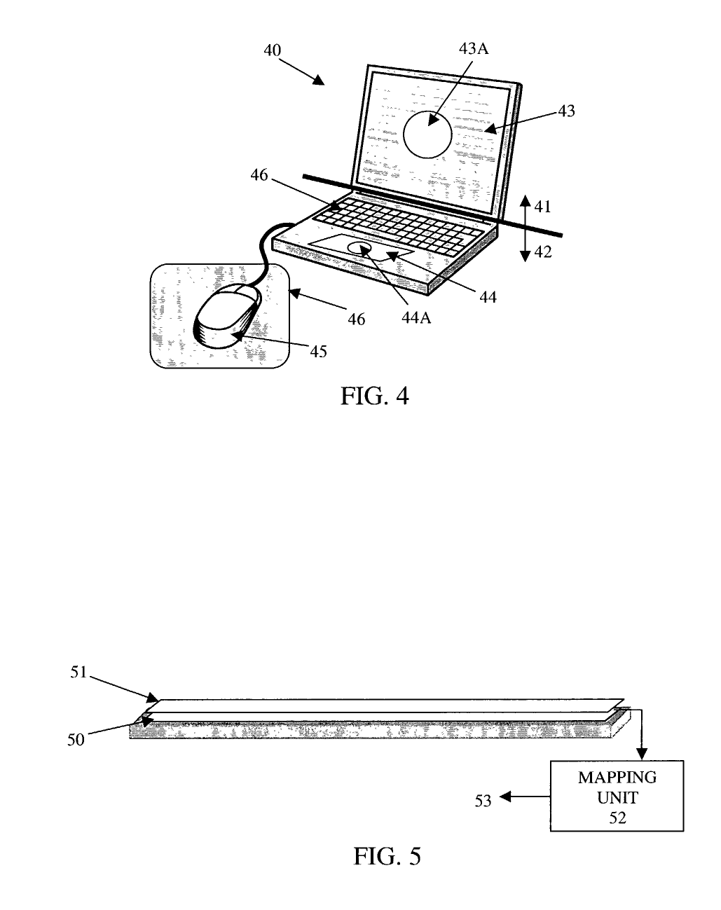

FIG. 5 illustrates an embodiment of an apparatus for receiving user input via tactile contact that can be used as a secondary display unit in a computing system including a first display screen that displays a full image. In particular, the apparatus includes a second display screen 50 for displaying an image and a means for receiving user tactile contact 51. The receiving means 51 is transparent and overlaid upon display screen 50. The receiving means 51 also functions to map the location of the user tactile contact on the receiving means to a coordinate location on the image displayed on display 50. In one embodiment, the receiving means includes a mapping unit 53 for receiving and converting signals corresponding to the tactile contact to coordinate location information 53. In one embodiment, the receiving means 51 includes a resistive or capacitive pressure sensitive layer overlaid on the display screen 50.

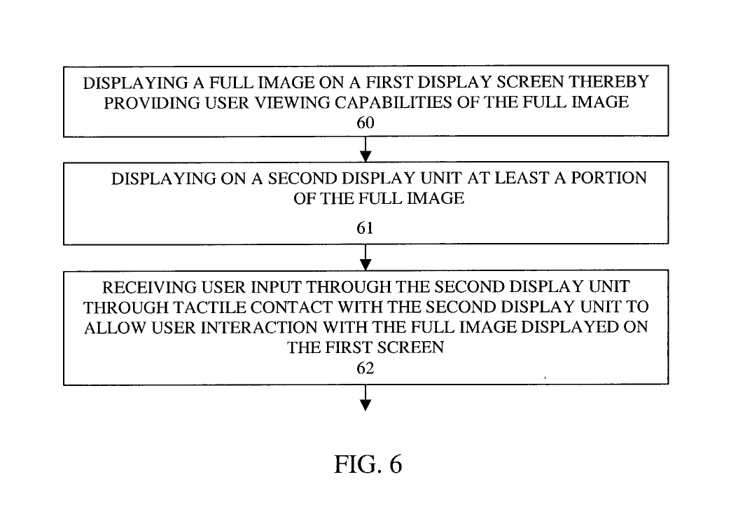

FIG. 6 shows an embodiment of a method of providing a user input to a computing system through a secondary touch sensitive display unit. According to method, a full image is displayed on a first display screen thereby providing a user with the capability to view the full image (block 60). Furthermore, at least a portion of the full image is displayed on a second display unit (block 61). For example, referring to FIG. 4, a full image (e.g., a circle 43A) is displayed on screen 43 and a corresponding full image (e.g., 44A) is displayed on display unit 44. The method further includes receiving user input through the second display unit through tactile contact with the second display unit (block 62) to allow user interaction with the full image displayed on the first screen. Specifically, the user can interact directly through tactile contact with their finger, a stylus, or the like to provide user input to the computer system. The method can further include mapping the location of the tactile contact to a coordinate location on the image displayed on the second display unit.

The method shown in FIG. 6 can further include integrating the computing system within a single chassis such that the first display screen and second display unit are housed within the same single chassis. In one embodiment, the method includes forming the single chassis by including a first portion for housing the first display screen and a second portion for housing the second display unit. According to this method, the first display screen displays a larger image than the second display unit. The first portion can be mechanically attached and foldable upon the second portion. It should be understood that the method can further include receiving user input through other input devices in conjunction with the second display as described above.

In accordance with the present invention, the method can further include magnifying or demagnifying the image displayed by the second display screen. As described above, image magnification facilitates the user's ability to interact through tactile contact with the image displayed by the second display unit. The method can further include displaying a portion or the full image that is displayed by the first display screen. Accordingly, the method can include selecting a portion of the full image displayed by the first display screen through the second display unit. In other words, the user can select by tactile contact with the second display unit a portion of the full image corresponding to the full image displayed by the first display screen and also displayed by the second display screen. Once selected, the portion of the full image is displayed by the second display unit.

Hence, a system, apparatus, and method is described for intuitively providing user input through a secondary display unit to a computing system having a primary display screen. Moreover, the user input system, apparatus, and method as described herein are particularly adaptive to portable computing systems, such as laptop computers since the secondary display unit can be sized to facilitate its integration into a single chassis along with the primary display screen, the processor, and the memory of the computing system.

In the preceding description, numerous specific details are set forth in order to provide a thorough understanding of the present invention. It will be apparent, however, to one skilled in the art that these specific details need not be employed to practice the present invention. In addition, it is to be understood that the particular embodiments shown and described by way of illustration is in no way intended to be considered limiting. Reference to the details of these embodiments is not intended to limit the scope of the claims.

I claim:

1. A computing system (40) comprising:
processing portion;
memory portion;
primary display screen (43) for displaying a full image;
secondary display unit (44) for displaying at least a portion of the full image and for receiving user input by tactile contact with the secondary display unit, the secondary display unit being smaller than the primary display screen, the secondary display unit being physically integrated within a single chassis along with the processing portion, the memory portion, and the primary display screen.

2. The system as described in claim 1 wherein the single chassis has a first portion (41) mechanically connected to, in electrical connection with, and foldable upon a second portion (42), the first portion for housing the primary display screen (43) and the second portion for housing the secondary display unit (44).

3. The system as described in claim 2 further comprising additional input devices (45, 46) including at least one of a mouse, a keyboard, and a touchpad, for using in conjunction with the secondary display unit (44).

4. The system as described in claim 1 wherein the secondary display unit displays a smaller version of the full image.

5. The system as described in claim 1 wherein the secondary display unit displays a portion of the full image.

6. The system as described in claim 5 wherein the secondary display unit displays one of a magnified and demagnified version of the image portion.

7. The system as described in claim 1 wherein the secondary display unit displays user interface control objects.

8. The system as described in claim 1 wherein the secondary display unit is one of a resistive and capacitive touch screen.

9. The system as described in claim 1 wherein the user input corresponds to user freehand drawing on the secondary display unit.

10. The system as described in claim 1 wherein the user input corresponds to user selection of interface control objects.

11. The system as described in claim 1 wherein tactile contact is made with a stylus.

12. The system as described in claim 1 wherein tactile contact is made by direct contact between the user and the secondary display unit.

13. The system as described in claim 1 wherein the display unit includes a display portion (50) for displaying the at least portion of the full image, a transparent pressure sensitive layer (51) overlaid on top of the display portion for receiving the tactile contact, and a mapping algorithm (52) for mapping the location of the tactile contact to a coordinate location on the at least a portion of the full image so as to allow user interaction with the full image displayed on the first display screen.

14. A computing system (40) comprising:
means for processing data;
means for storing data;
first means (43) for displaying a full image;
second means (44) for displaying at least a portion of the full image and for receiving user input by tactile contact with the second means, the second means displaying a smaller image than the first display means, the second means being physically integrated within a single chassis along with the processing portion, the memory portion, and the first display means.

15. A method of providing user input to a computing system comprising:
displaying a full image on a first display screen thereby providing user viewing capabilities of the full image (60);
displaying on a second display unit at least a portion of the full image (61);
receiving user input through the second display unit through tactile contact with the second display unit to allow user interaction with the full image displayed on the first screen (62).

16. The method as described in claim 15 further comprising integrating the computing system within a single chassis such that the first display screen and second display unit are housed within the same single chassis.

17. The method as described in claim 16 further comprising forming the single chassis by including a first portion for housing the first display screen and a second portion for housing the second display unit, the first display screen displaying a larger image than the second display unit, the first portion being mechanically attached and foldable upon the second portion.

18. The method as described in claim 15 comprising receiving user input through other input devices in conjunction with the second display unit.

19. The method as described in claim 15 further comprising mapping the location of the tactile contact to a coordinate location on the at least a portion of the full image.

20. The method as described in claim 15 further comprising one of magnifying and demagnifying the at least a portion of the full image displayed by the second display unit.

21. The method as described in claim 15 further comprising only displaying interface control objects on the second display unit.

22. An apparatus for receiving user input in a computing system, the computing system including at least a first display screen (43) for displaying a full image, the apparatus comprising:
a second display screen (50) for displaying at least a portion of the full image, said second display screen being smaller than the first display screen;
a means for receiving user tactile contact (51, 52), the receiving means being transparent and overlaid upon the second display screen and mapping the location of the tactile contact to a coordinate location on the at least a portion of the full image so as to allow user interaction with the full image displayed on the first display screen;
wherein the second display screen is integrated within a single chassis with the first display screen (44).

23. The apparatus as described in claim 22 wherein the means for receiving tactile contact from the user includes one of a resistive and capacitive pressure sensitive layer overlaid on the second display screen thereby forming a touch screen.
